(19) United States
(12) Patent Application Publication
(10) Pub. No.: US 2008/0085135 A1
(43) Pub. Date: Apr. 10, 2008

(54) Full glass platen scan to simplex or duplex copy

(75) Inventor: Kenneth James Rieck, Victor, NY (US)

Correspondence Address: ORTIZ & LOPEZ, PLLC, P.O. Box 4484, Albuquerque, NM, 87196-4484, US

(73) Assignee: Xerox Corporation

(21) Appl. No.: 11/544,427

(22) Filed: Oct. 6, 2006

(51) Int. Cl. G03G 15/00

(52) U.S. Cl. 399/204

(57) ABSTRACT

A rendering method, system and program product. A single functional instruction among a plurality of functional instructions can be provided by a rendering device and selected by a user in order to scan a document platen associated with the rendering device, thereby creating via the rendering device, a representation of the scanned documents. The representation of documents can be automatically divided into a left half and a right half. Thereafter, the representation of the documents can be rendered such that the left half and the right half of the representation of the documents are rendered on separate substrates, thereby creating a full glass scan to simplex copy of the documents.

### TECHNICAL FIELD

Embodiments are generally related to rendering devices, systems, and methods. Embodiments are also related to copying methods and systems. Embodiments are also related to printing techniques and devices.

### BACKGROUND

Rendering devices such as copying and printing machines have been developed with different modes of copying and printing. Machine copy/printing modes, for example, may include various copying functions such as book copying, two-sided book copying, mixed-sized originals, image rotation, edge erasing, negative imaging capabilities, booklet creation, poster mode, and multi-functional operations, to name just a few. Printing modes can include simplex or duplex printing, booklet printing, folding, stapling and collating options. The development of a number of different copying/printing modes can enhance a user's capabilities with respect to a particular print job.

A book copying mode is designed to copy an open book. In such a mode, if a user desires to copy either a page or a group of pages, the user simply places the open book on a glass document platen. In most copying machines, for example, the book is typically placed face down in the back left corner of the document platen. The book copy mode typically provides for user defined options available in the selection of the final printing. The factory default allows both sides of the open book on the document platen to be copied and printed on a single page. Other modes available in book copy mode may include “Both Pages” such that both the left and right pages are copied and printed as separate images on two sheets of paper. The user may also select to copy and print only the left or right page of a book on the document platen.

Various other options are available to a user under the book copy mode. Depending on the individual rendering device, the user may be able to select “gutter erase” wherein the user specifies the measurement of the distance between the left and right pages. Another option involves selecting a “Create Booklet” option, wherein several original pages of the book to be copied are printed on a single sheet of paper in the proper order so that the copy pages can be folded into a booklet.

Simplex or duplex printing options must be selected prior to the printing/copying process. Simplex printing involves printing each image on a single sheet of paper. Simplex printing can be accomplished even when the “book copy” mode is selected and wherein the entire document platen is scanned, creating two printed pages; one page for the left side of the document platen and one page for the right side of the document platen. Duplex printing involves printing each image on opposite sides of the same page, wherein the left side of the document platen is printed on the front side of the page and the right side of the document platen is printed on the back side of the page.

A system for copying documents or bound books is disclosed in U.S. Pat. No. 5,012,275, which issued to Bock on Apr. 30, 1991 and is assigned to the Xerox Corporation of Stamford, Conn., U.S.A. U.S. Pat. No. 5,012,275 is directed to an electro-photographic reproduction machine which incorporates a document platen having an angled book edge and which utilizes a scanning system which scans from right-to-left (instead of the conventional left-to-right). The scanning operation is enabled by first detecting by an optical sensor the right hand edge of a document to be copied, the left edge of the document being registered at the left edge of the document platen. The scanning operation is initiated at the detected right hand edge and proceeds to the left. The end of scan coincides with the left registration edge. Book copying is enabled by adding a sloping left edge to the platen placing the book to be copied over the edge corner. U.S. Pat. No. 5,012,275 is incorporated herein by reference.

U.S. Pat. No. 5,634,187, which issued to Ross on May 27, 1997 and is assigned to the Xerox Corporation of Stamford, Conn., U.S.A., discloses an automatic simplex and duplex copying system wherein a system is provided for automatically selecting duplex copying whenever appropriate. The controller automatically selects duplex copying unless there is a signal from a document input sensor such as a semi-automatic document input or a sensor sensing the lifting of the document handler, or, even though the document input normally used for copying plural documents is the input tray of an automatic recalculating document handler unit, a downstream sensor detects that only a single document was fed from that tray to be copied. U.S. Pat. No. 5,634,187 in incorporated herein by reference.

Book copy mode is one mode which a user may utilize to copy more than one document. If a user had two documents to copy, the two documents could be copied in one job by placing both documents carefully on the document platen in the correct positions, entering the book copy mode, selecting “both pages”, and selecting “gutter erase” if desired. Alternatively, two documents could be copied as two separate jobs of single copies. The documents would each have to be carefully placed and aligned in the correct location on the document platen, the cover closed and “copy” selected. Either method involves several steps, making a seemingly simple job of copying two documents more complex.

A user with a print job of two documents of differing sizes such as a document and a check to copy or possibly a document and a cancelled envelope would need to go through the complex process of “book copy” mode to make a duplex (single page) copy or a simplex (two sheets) copies. A need therefore exists to simplify the process of making multiple document copies in a single scan. The present invention solves this problem by making the process of multiple documents copying more intuitive and simple.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved method, system and/or program product that provides for a single full glass platen scan copy to a simplex print.

It is another aspect of the present invention to provide for an improved method, system and/or program product to implement a single full glass platen scan copy to a duplex print.

The aforementioned aspects and other objectives and advantages can now be achieved as described herein. A rendering method, system and program product is disclosed. A plurality of documents located on a document platen associated with a rendering device can be scanned, and a representation of the plurality of documents created via the rendering device. Next, the representation of the plurality of documents can be divided into a left half and a right half. Thereafter, the representation of the plurality of documents can be rendered wherein the left half and the right half of the representation of the plurality of documents are rendered on separate substrates, thereby creating a full glass scan to simplex copy of the plurality of documents.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 is a perspective view of a rendering device for rendering a document, which can be adapted for use in accordance with one or more embodiments;

FIG. 2 illustrates an example of an alternative digital data copier that can be adapted for use in accordance with one or more embodiments;

FIG. 3 illustrates a block diagram of a document platen with two different sized documents to be scanned; in accordance with an embodiment;

FIG. 4 illustrates a high-level flowchart of operations illustrating logical operational steps to complete a full glass platen scan, in accordance with a preferred embodiment;

FIG. 5 illustrates a continuation of the flowchart depicting in FIG. 4 depicting logical operational steps for completing a simplex print of a full glass platen scan, in accordance with an alternative embodiment;

FIG. 6 illustrates a continuation of the flowchart depicted in FIG. 4, illustrating logical operational steps for completing a duplex print of a full glass platen scan, in accordance with an alternative embodiment;

FIG. 7 illustrates both a simplex and a duplex printout from a full glass platen scan, in accordance with a preferred embodiment; and

FIG. 8 illustrates block diagram of a data-processing apparatus that can be implemented in accordance with a preferred embodiment.

### DETAILED DESCRIPTION

The particular values and configurations discussed in these non-limiting examples can be varied and are cited merely to illustrate at least one embodiment and are not intended to limit the scope thereof.

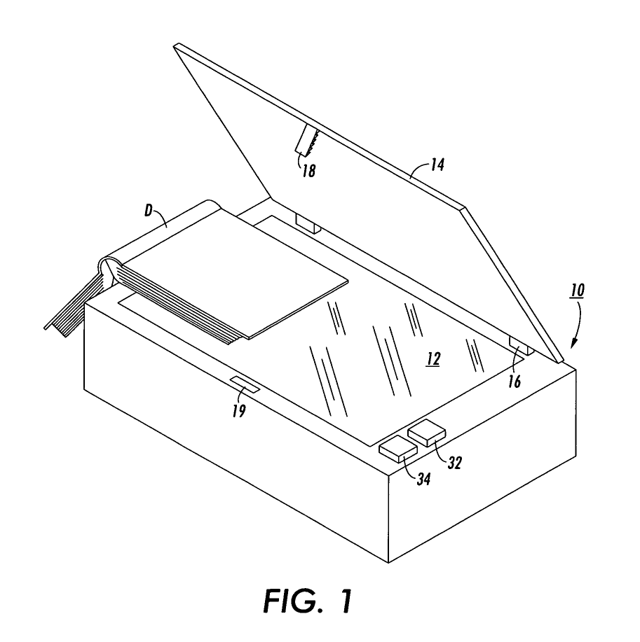

FIG. 1 is a perspective view of a rendering device 10 for rendering a document, which can be adapted for use in accordance with one or more embodiments. The device 10 can be either a copier, which would also outputs copies or other prints, or simply be a stand-alone scanner which outputs digital data based on images recorded from scanned documents. The device 10 includes a light-transmissive platen 12, suitable for bearing documents to be scanned, and a platen cover 14, which is pivotably mounted relative to the platen 12 by one or more hinges 16. The platen cover 14 can be in an open position, as shown in FIG. 1, or can be lowered into a “closed” position, in which the platen cover in effect urges a document against the platen 12 for clear, focused recording of the image thereon. In the illustration of FIG. 1, the document D in question is an open book, but a document can be any object or artifact having or forming a recordable image, such as a single sheet of paper, a package, a small item, etc. In order for platen cover 14 to urge a relatively thick item such as a book onto platen 12, the hinges 16 may have to be specially adapted with slide mounts or extra joints, but basic designs for such hinges are generally known in the art.

In situations where it is desired to record images from a series of odd-shaped documents which must be manually placed on platen 12, the position of platen cover 14 at any time can be automatically monitored, by a control system within scanner 10, and used to activate a scanning operation by device 10. In the illustrated embodiment, extending from platen cover 14 is what can be called a ratchet member 18, which, as platen cover 14 approaches a closed position, is inserted into an opening 19. The ratchet member 18 defines teeth, which can be engaged by a pawl member near opening 19.

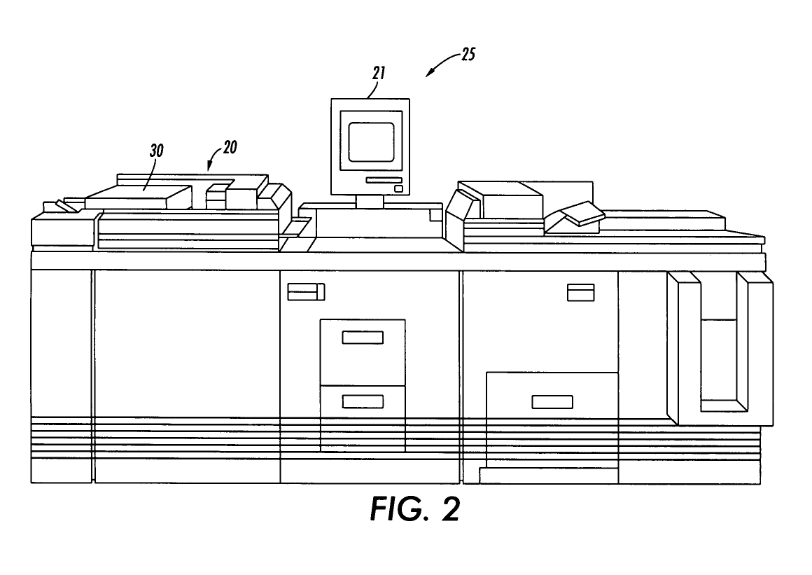

FIG. 2 illustrates an example of an alternative rendering device 25 that can be adapted for use in accordance with one or more embodiments. The rendering device 25 can be implemented as a digital data copier. It can be appreciated that the rendering device 25 depicted in FIG. 2 represents only one of many possible digital data copiers that can be utilized in accordance with a preferred or alternative embodiments. Rendering device 25 is illustrated herein for exemplary purposes only and is not considered a limiting feature of the embodiments. Rendering device 25 generally includes a digital scanning device 20 that digitally scans documents for eventual reproduction and printing. Rendering device 25 also can include a user interface 21 that permits a user interact with and initiate digital data copying functions, such as, for example, digital photocopying and reproduction. Rendering device 25 utilizes a document handling unit 30 that can sequentially feed documents from a stack of documents into the rendering device 25 for digital copying, reproduction and rendering. Associated with the document handling unit is a device platen (not shown in FIG. 2) similar to the platen 12 depicted in FIG. 1 upon which a user can place a document for digital copying and rendering.

Digital data copier or rendering device 25 can, for example, be configured to include a plurality of output paper stock sizes via provided the rendering device in order to generate the rendered document, along with a software module for detecting output document sizes available to the rendering device in response to automatically detecting the minimum text size of text contained in the original document specifying the particular minimum text size based on the user input. The rendering device 25 may also include a user interface associated with the rendering device, wherein the user interface collects at least one user reproduction preference.

The various functions of rendering device 25 can be regulated by a controller which preferably comprises one or more programmable microprocessors. The controller provides a comparison count of the copy sheets, the number of documents being re-circulated, the number of copy sheets selected by the operator, time delays, jam corrections, etc. Programming and operating control over rendering device 25 can be accomplished through a user Interface such as the user interface device 21. Operating and control information, job programming instructions, etc. can be stored in a suitable memory, which includes both ROM and RAM memory types. Conventional sheet path sensors or switches may be utilized to keep track of the position of the documents and the copy sheets. In addition, such a controller can regulate the various positions of the gates depending upon the mode of operation selected.

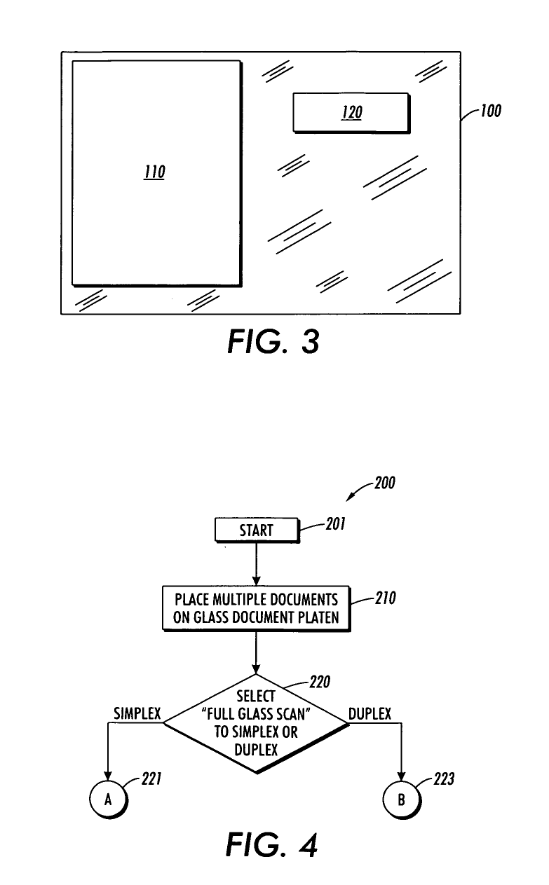

FIG. 3 illustrates the document platen 100 with two different sized documents 110 and 120 to be scanned. Note that one possible implementation of document platen 100 is platen 12 depicted in FIG. 1. The documents 110 and 120 are shown in FIG. 3 for illustrative purposes as being of different sizes, but the documents 110 and 120 may be the same size and may also be more than two documents and may also be different shapes. The documents placed on the glass platen 100 must only be contained within the boundaries of the glass platen 100 in order to be copied. There is no limit on the number, the size or the shape of the documents 110 and 120 to be copied, as long as all of the documents do not extend outside of the document platen.

FIG. 4 illustrates a flowchart outlining the steps of a method 200 for completing a full glass platen scan in accordance with a preferred embodiment. Method 200 can begin, as indicated at block 201. In order make a full glass platen scan as shown in the flowchart of method 200 depicted in FIG. 4, a user can place the multiple documents 110 and 120 to be copied upon the glass platen as illustrated at block 210. Thereafter, the operation depicted at block 220 can be implemented, such that a user is permitted to select “Full Glass Scan to Duplex” or “Full Glass Scan to Simplex” utilizing an interface such as user interface 21 depicted in FIG. 2. This option of a “Full Glass Scan” as described at block 220 can be provided as an option in an output selection tab on a list of functions of a rendering device (e.g., rendering devices 10 and/or 25) or could be implemented as an independent selection with a dedicated button or other selection means.

The selection of a “Full Glass Scan” as depicted at block 220 is meant for a user to quickly select a function to scan the entire glass document platen without selecting the “Book Copy” function or any other non-intuitive mode of copying multiple documents and working through multiple menu functions. Multiple documents 110 and 120, such as a letter and a check, a letter and an envelope, receipts and a check, or any other user defined set of multiple documents could be placed on the document platen and quickly copied. The process then continues as indicated at blocks 221 and/or 223.

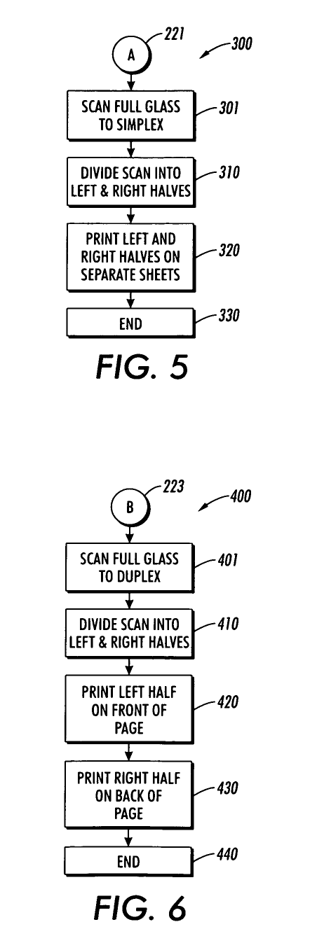

FIG. 5 illustrates the continuation of the flowchart of FIG. 4 outlining additional method 300 step for completing a simplex print of a full glass platen scan. Note that in FIGS. 4-6 identical or similar parts or elements are generally indicated by identical reference numerals. As indicated at block 301, a “Full Glass Scan to Simplex” operation can be selected. After the “Full Glass Scan to Simplex” has selected, the rendering device can scan the entire glass document platen 100. All of the documents on the glass document platen 100 will be scanned during this operational step. After the scan, the rendering device can, as illustrated at block 310, divide the scan into a left and a right half, where the left half corresponds to the left half of the document platen 100 and the right half corresponds to the right half of the document platen 100. The operation depicted at block 320 illustrates the completion of the scan/print job by printing the left half of the scan on the first page printed and the right half of the scan on a separate second page, completing the scan/print job as depicted at block 330.

FIG. 6 illustrates the continuation of the flowchart of FIG. 4 outlining the method 400 logical operational steps for completing a duplex print of a full glass platen scan. Methods 200, 300, and 400 thus represent continuations of the same methodology and flow chart. Block 401 of method 400 indicates a scanning operation via a rendering device. Such a scanning operation involves a “Full Glass Scan to Duplex” operation. After the “Full Glass Scan to Duplex” option is selected by a user, the rendering device can scan the entire glass document platen 100 as indicated at block 401. All of the documents on the glass document platen 100 are scanned during the operation illustrated at block 401. After the scan, the rendering device will, as depicted at block 410, divide the scan into a left and a right half. Thereafter, as indicated at block 420, the left half of the scan is rendered on a front side of a single sheet of paper and as next, as illustrated at block 430, the right half of the scan is rendered on the back of the same sheet of paper. The operations can then terminate as indicated at block 440.

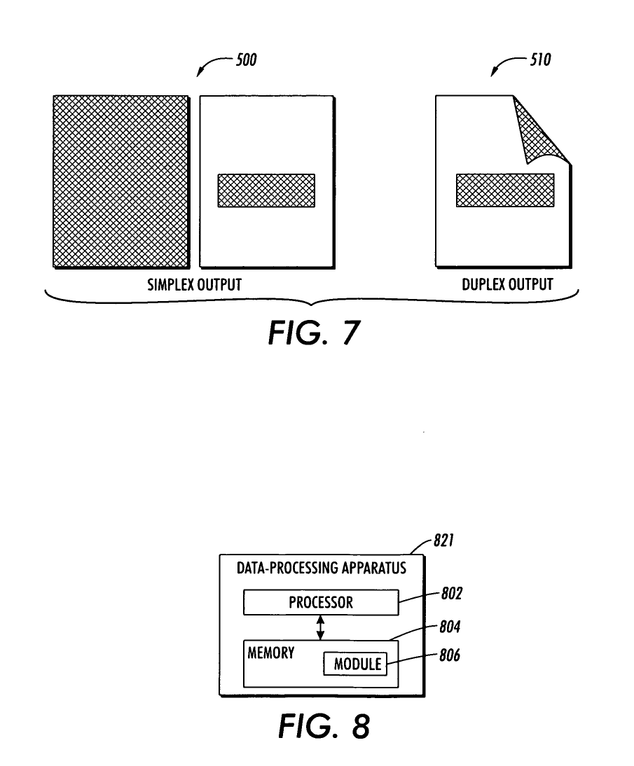

FIG. 7 illustrates a completed scan/print job as either a simplex print 500 or a duplex print 510. The selection of a full glass scan to simplex, illustrated in the steps in FIG. 5, results in print job 500, wherein the left half of the scan is printed on a first page and the right half of the scan is printed on a second page. The alternate selection of a full glass scan to duplex, illustrated in the steps in FIG. 6, results in print job 510, wherein the left half of the scan is printed on the front of a page and the right half is printed on the back of the same page.

FIG. 8 illustrates a block diagram of a data-processing apparatus 821 that can be implemented in accordance with a preferred embodiment. Note that the data-process apparatus 821 can be associated and/or integrated with a rendering device such as rendering devices 10 and/or 25 described earlier. Data-processing apparatus 821 (and hence rendering devices 10 and/or 25) can be provided in the context of a software module 806 that is stored in a memory 804 and which can be retrieved and processed by a processor 802. In general, data-processing apparatus 821 can be composed of one or more processor readable storage devices (e.g., memory 804) having a processor readable code (e.g., software module 806) embodied on one or more of the processor readable storage devices, the processor readable code for programming one or more processors (e.g., 802) to perform a particular activity. Data-processing apparatus 821 thus can be implemented as a computer.

Note that the embodiments disclosed herein can be implemented in the context of a host operating system and one or more module(s) such as module 806. Module 806 (e.g., instruction media residing in a computer) can thus be used to implement the operational steps depicted in FIGS. 4-6 herein. In the computer programming arts, a software module can be typically implemented as a collection of routines and/or data structures that perform particular tasks or implement a particular abstract data type. Software modules generally comprise instruction media storable within a memory location of a data-processing apparatus and are typically composed of two parts. First, a software module may list the constants, data types, variables, routines and the like that can be accessed by other modules or routines. Second, a software module can be configured as an implementation, which can be private (i.e., accessible perhaps only to the module), and that contains the source code that actually implements the routines or subroutines upon which the module is based. The term module, as utilized herein can therefore refer to software modules or implementations thereof. Such modules or instruction media can be utilized separately or together to form a program product that can be implemented through signal-bearing media, including transmission media and recordable media.

Although the data-processing apparatus 821 can be implemented in the context of a fully functional data-processing apparatus, those skilled in the art will appreciate that the mechanisms of the present invention are capable of being distributed as a program product in a variety of forms, and that the present invention applies equally regardless of the particular type of signal-bearing media utilized to actually carry out the distribution. Examples of signal bearing media include, but are not limited to, recordable-type media such as floppy disks or CD ROMs and transmission-type media such as analogue or digital communications links.

Any type of computer-readable media that can store data that is accessible by a computer, such as magnetic cassettes, flash memory cards, digital versatile discs (DVDs), Bernoulli cartridges, random access memories (RAMs), and read only memories (ROMs) can be used in connection with the embodiments.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A rendering method, comprising:
selecting a single functional instruction from among a plurality of functional instructions provided by a rendering device in order to scan a plurality of documents located on a document platen associated with said rendering device and thereby create via said rendering device, a representation of said plurality of documents;
automatically dividing said representation of said plurality of documents into a left half and a right half in response to selecting said single functional instruction; and
rendering said representation of said plurality of documents via said rendering device, wherein said left half and said right half of said representation of said plurality of documents are rendered on separate substrates, thereby creating a full glass scan to simplex copy of said plurality of documents.

2. The method of claim 1 wherein each document among said plurality of documents is of a different size.

3. The method of claim 1 wherein each document among said plurality of documents is of a different shape.

4. The method of claim 1 further comprising selecting said single functional instruction from a user interface associated with said rendering device.

5. The method of claim 4 further comprising selecting said single functional instruction in order to scan said document platen, utilizing an output selection tab associated with said user interface.

6. The method of claim 4 further comprising selecting said single functional instruction in order to scan said document platen, utilizing a dedicated full glass scan button associated with said rendering device.

7. The method of claim 1 wherein said left half of said representation of said plurality of documents corresponds to a left half of said document platen and said right half of said representation of said plurality of documents corresponds to a right half of said document platen.

8. A computer implemented system for rendering a document, comprising:
a data-processing apparatus;
a module executed by said data-processing apparatus, said module and said data-processing apparatus being operable in combination with one another to:
permit a user to select a single functional instruction from among a plurality of functional instructions provided by a rendering device in order to scan a plurality of documents located on a document platen associated with said rendering device and thereby create via said rendering device, a representation of said plurality of documents;
automatically divide said representation of said plurality of documents into a left half and a right half in response to selecting said single functional instruction; and
render said representation of said plurality of documents via said rendering device, wherein said left half and said right half of said representation of said plurality of documents are rendered on separate substrates, thereby creating a full glass scan to simplex copy of said plurality of documents.

9. The system of claim 8 wherein each document among said plurality of documents is of a different size.

10. The system of claim 8 wherein each document among said plurality of documents is of a different shape.

11. The system of claim 8 wherein said data-processing apparatus and said module are further operable in combination with one another to permit said user to select said single functional instruction from a user interface associated with said rendering device.

12. The system of claim 11 wherein said data-processing apparatus and said module are further operable in combination with one another to permit said user to select said single functional instruction in order to scan said document platen, utilizing an output selection tab associated with said user interface.

13. The system of claim 11 wherein said data-processing apparatus and said module are further operable in combination with one another to permit said user to select said single functional instruction in order to scan said document platen, utilizing a dedicated full glass scan button associated with said rendering device.

14. The system of claim 8 wherein said data-processing apparatus and said module are further operable in combination with one another to permit said left half of said representation of said plurality of documents to correspond to a left half of said document platen and said right half of said representation of said plurality of documents to correspond to a right half of said document platen.

15. A program product, comprising:
instruction media residing in a computer for permitting a user to select a single functional instruction from among a plurality of functional instructions provided by a rendering device in order to scan a plurality of documents located on a document platen associated with said rendering device and thereby create via said rendering device, a representation of said plurality of documents;
instruction media residing in a computer for automatically dividing said representation of said plurality of documents into a left half and a right half in response to selecting said single functional instruction; and
instruction media residing in a computer for rendering said representation of said plurality of documents via said rendering device, wherein said left half and said right half of said representation of said plurality of documents are rendered on separate substrates, thereby creating a full glass scan to simplex copy of said plurality of documents.

16. The program product of claim 15 wherein each document among said plurality of documents is of a different size.

17. The program product of claim 15 wherein each document among said plurality of documents is of a different shape.

18. The program product of claim 15 further comprising instruction media residing in a computer for permitting said user to select said single functional instruction from a user interface associated with said rendering device.

19. The program product of claim 18 further comprising instruction media residing in a computer for permitting a user to select said single functional instruction in order to scan said document platen, utilizing an output selection tab associated with said user interface.

20. The program product of claim 15 further comprising instruction media residing in a computer for permitting a user to select said single functional instruction in order to scan said document platen, utilizing a dedicated full glass scan button associated with said rendering device.
